(19) United States
(12) Patent Application Publication
(10) Pub. No.: US 2013/0168444 A1
(43) Pub. Date: Jul. 4, 2013

(54) ELECTRONIC TAG, UPDATING METHOD THEREOF AND ELECTRONIC TAG SYSTEM

(71) Applicants: KUAN-HONG HSIEH, New Taipei (TW); HAN-CHE WANG, New Taipei (TW); HSIN-NAN HU, New Taipei (TW); JUN-XIN CHAI, Shenzhen (CN)

(72) Inventors: KUAN-HONG HSIEH, New Taipei (TW); HAN-CHE WANG, New Taipei (TW); HSIN-NAN HU, New Taipei (TW); JUN-XIN CHAI, Shenzhen (CN)

(21) Appl. No.: 13/726,557

(22) Filed: Dec. 25, 2012

(30) Foreign Application Priority Data
Dec. 30, 2011 (CN) 201110453371.1

(51) Int. Cl. G09G 3/00

(52) U.S. Cl. CPC G09G 3/001
USPC 235/375

(57) ABSTRACT

An electronic tag includes a screen, a barcode input interface configured for receiving a barcode, a wireless communication unit configured for sending the barcode to a host and receiving an updated content associated with the barcode code sent by and from the host, a driving unit configured for driving the screen to display the updated content. The electronic tag can rapidly and accurately get the article data that corresponds to the barcode of the article and display the content of the article data on the screen to update the original display.

### BACKGROUND

1. Technical Field

The present disclosure relates to the field of labeling products, particularly to an electronic tag, a method for updating the content displayed on the electronic tag and a electronic tag system.

2. Description of Related Art

Electrophoretic displays have low power consumption because of the bistable characteristic and the visual aspect can be maintained without needing a continuously applied voltage. Because of such advantages, an electronic price tag employing such electrophoretic display is used in order to provide price information that can be modified easily and without the requirement of replacing physical price tags on goods each time the price of the goods is changed. The price information and other contents displayed on the electronic price tag can be updated via radio frequency identification (RFID).

The electronic price tag is passively updated by a server or external reader via RFID, the electronic price tag cannot actively get the update information from the server. Furthermore, the transmission performance of the RFID is less than 5 meters, the electronic price tags of related art are not suitable for large stores or rooms with goods dispersed over a large area. Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present disclosure. Moreover, in the drawings, like reference numerals designate corresponding parts throughout the several views.

FIG. 1 is an assembled, isometric view of an electronic tag in accordance with a first embodiment.

FIG. 2 is a block diagram of the electronic tag of FIG. 1.

FIG. 3 is a schematic view illustrating an electronic tag system for updating contents displayed on the electronic tag of FIG. 1 in accordance with the first embodiment.

FIG. 4 is a flowchart of an updating method to update the contents displayed on the electronic tag of FIG. 1 in accordance with the first embodiment.

FIG. 5 is a schematic view illustrating an electronic tag system for updating content displayed on an electronic tag in accordance with a second embodiment.

FIG. 6 is a flowchart of a method for updating the content displayed on the electronic tag in accordance with the second embodiment.

FIG. 7 is a schematic view illustrating an electronic tag system for updating content displayed on an electronic tag in accordance with a third embodiment.

FIG. 8 is a flowchart of a method for updating the content displayed on the electronic tag in accordance with the third embodiment.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean “at least one.”

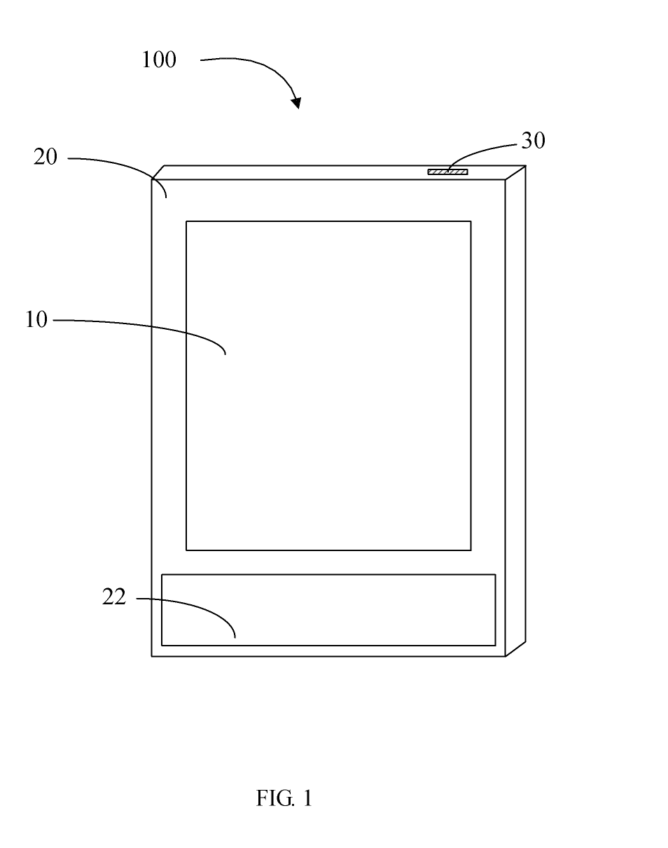

FIG. 1 shows an electronic tag 100 in a first embodiment. The electronic tag 100 includes an electronic paper (E-paper) screen 10, a housing 20, a barcode input interface 30 and a solar panel 22 arranged on an external surface of the housing 20. The E-paper screen 10 may be a reflective display, such as electrophoretic paper display (EPD), cholesteric liquid crystal display (ChLCD), electrowetting display (EWD) or interferometric modulator display (IMOD) with bistable characteristics. In this embodiment, the E-paper screen is a microcapsule electrophoretic display.

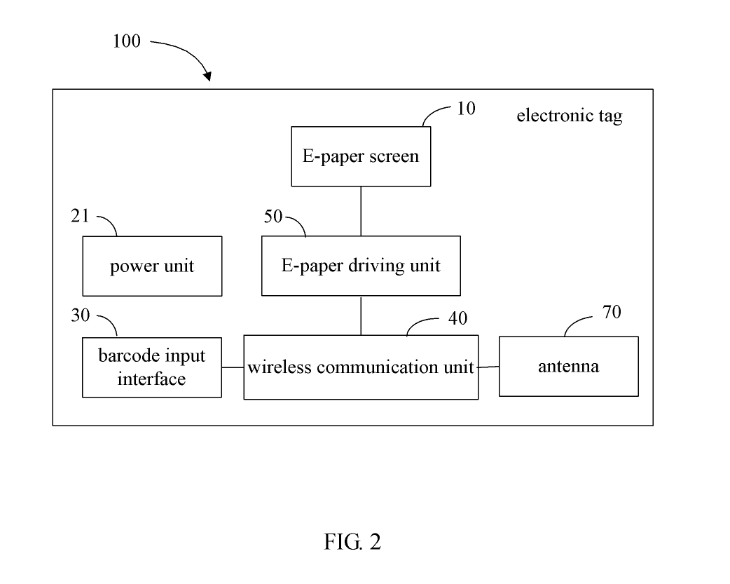

Referring to FIG. 2, the electronic tag 100 further includes a wireless communication unit 40, an E-paper driving unit 50, a power unit 21 and an antenna 70. The power unit 21 is connected to the solar panel 22 for storing the electricity generated by the solar panel 22, and applies electrical power to the electronic tag 100. The wireless communication unit 40 is connected to the E-paper driving unit 50 and the barcode input interface 30, the E-paper screen 10 is driven by the E-paper driving unit 50 to display different contents.

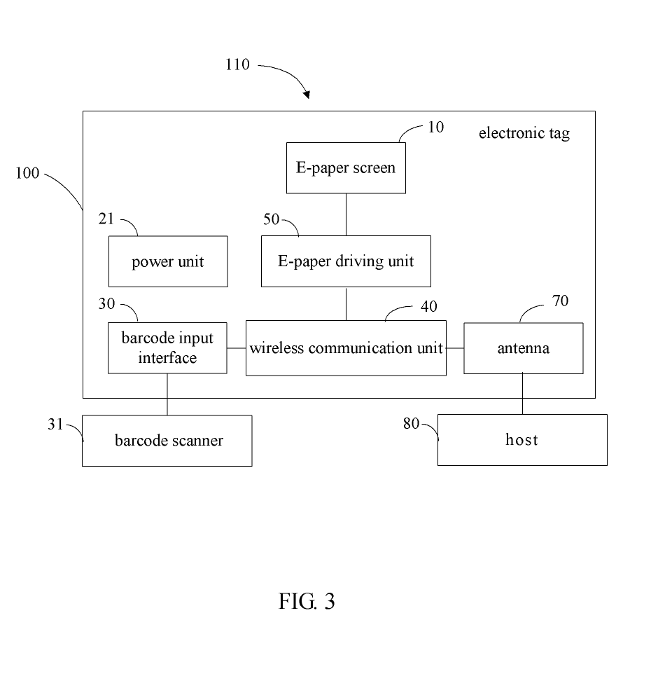

Referring to FIG. 3, an electronic tag system 110 for updating content displayed on the electronic tag 100 is illustrated. The electronic tag system 110 further includes a barcode scanner 31 connected to the barcode input interface 30 and a host 80. The electronic tag 100 communicates with the host 80 via the wireless communication unit 40, the host 80 can communicate with a number of such electronic tags 100 in a electronic tag system 110. The barcode scanner 31 is capable of scanning a barcode of an article, product or merchandise to obtain a barcode code, the barcode scanner 31 further sends the barcode code to the electronic tag 100. The barcode input interface 30 receives the barcode code sent by the barcode scanner 31, and the wireless communication unit 40 sends the barcode code to the host 80 via the antenna 70.

The host 80 may be a computer or a server, the host includes a database recording a number of item data of articles. The item data includes the barcode code, price, name, production date or other information of the articles. The host 80 receives the barcode code sent by the electronic tag 110, and determines there is a barcode code stored in a database of the host matching with the barcode code sent from the electronic tag 100. If yes, the host 80 obtains an updated content associated with the barcode code stored in the database, and sends the updated content to the electronic tag 100. The updated content is the item data of the article associated with the barcode code determined by the host 80.

The wireless communication unit 40 of the electronic tag 110 receives the updated content, the E-paper driving unit 50 drives the E-paper screen 10 to display the updated content. In detail, the E-paper driving unit 50 drives the E-paper screen 10 to display the item data of the article including the barcode code, price, name, production date and other information.

Different articles have different barcodes, the host 80 searches the database to determine whether there is a barcode stored in the database matching with the received code. With such configuration, the electronic tag 110 can rapidly and accurately get the updated content that corresponds to the barcode code obtained by the barcode scanner 31 and display the updated content on the E-paper screen 10, to update the original contents.

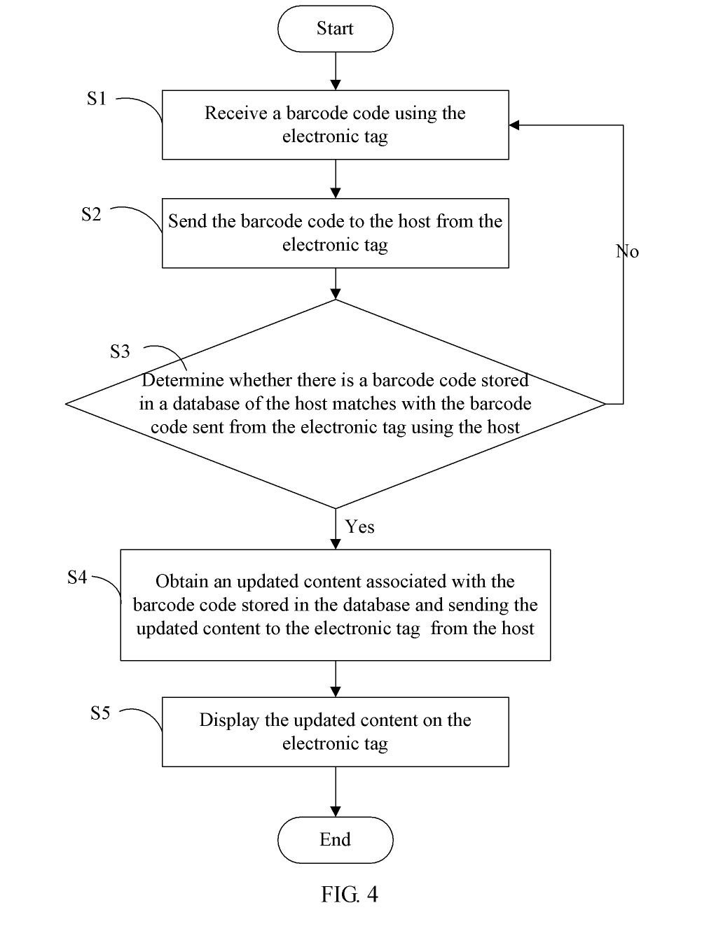

Referring to FIG. 4, a flowchart of a method for updating the content displayed on the electronic tag 100 according to a first embodiment is illustrated. The method includes the following steps, each of which is tied to various components contained in the electronic tag 100 and the electronic tag system 110 as shown in FIGS. 1-3.

In step S1, receiving a barcode code using the electronic tag 100. The barcode scanner 31 is capable of scanning the barcode of the article and sends the barcode code to the electronic tag 100, the barcode input interface 30 of the electronic tag 100 receives the barcode code of the article sent by the barcode scanner 31.

In step S2, sending the barcode code to the host 80 from the electronic tag 100. The wireless communication unit 40 of the electronic tag 100 sends the barcode code to the host 80.

In step S3, determining whether there is a barcode code stored in a database of the host 80 matches with the barcode code sent from the electronic tag 100 using the host 80, if yes, go to step S4; if not, the process ends. The host 80 receives the barcode code sent by the electronic tag 100, and determines whether there is a barcode code stored in the database of the host 80 matching with the received barcode code sent from the electronic tag 100.

In step S4, obtaining an updated content associated with the barcode code stored in the database and sending the updated content to the electronic tag 100 from the host 80. The host 80 obtains an updated content associated with the barcode code stored in the database, and sends the updated content to the electronic tag 100.

In step S5, displaying the updated content on the electronic tag 100. The wireless communication unit 40 of the electronic tag 110 receives the updated content, the E-paper driving unit 50 drives the E-paper screen 10 to display the updated content.

In other embodiments, the barcode scanner 31 and the electronic tag 100 can be integrated together, namely, a barcode scanner module is designed into the electronic tag 100.

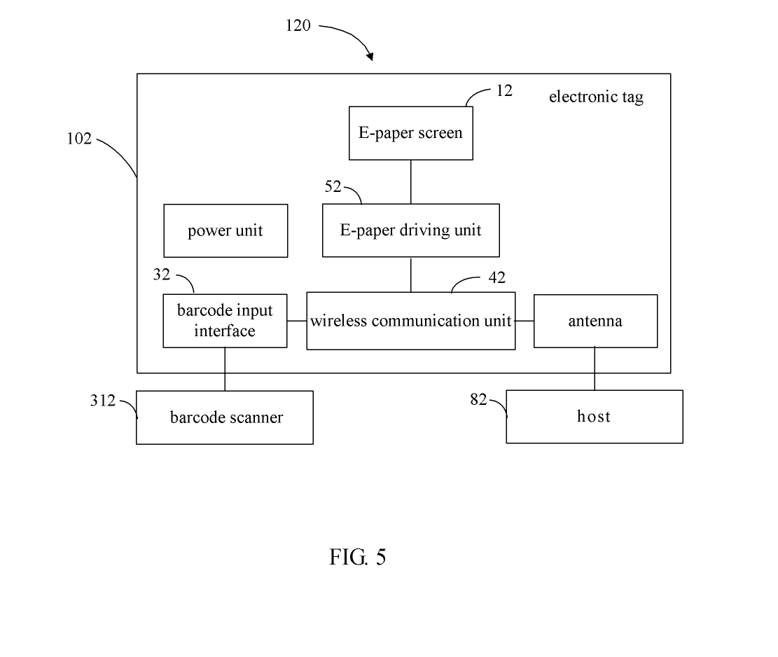

FIG. 5 shows an electronic tag system 120 for updating the content displayed on an electronic tag 102 in accordance with a second embodiment. The electronic tag system 120 is similar to the electronic tag system 110 described above, the electronic tag system 120 includes an electronic tag 102, a barcode scanner 312 connected to the electronic tag 102 and a host 82. The electronic tag 102 includes an E-paper screen 12 a barcode input interface 32, a wireless communication unit 42 and an E-paper driving unit 52. The difference between the electronic tag systems 120 and 110 is that the wireless communication unit 42 of each electronic tag 102 in the electronic tag system 120 includes a media access control address.

The barcode scanner 312 scans a barcode of article and sends the barcode code to the electronic tag 102. The electronic tag 102 receives the barcode code via the barcode input interface 32, the wireless communication unit 42 sends the barcode code and the media access control address of the electronic tag 102 to the host 82.

As in the first embodiment, the host 82 may be a computer or a server including a database with a number of item data of articles stored therein. The host 80 determines whether there is a barcode code stored in the database matching with the barcode code sent from the electronic tag 102. The host 82 obtains an updated content associated with the barcode code stored in the database and sends the updated content to the electronic tag 102 according to the media access control address of the electronic tag.

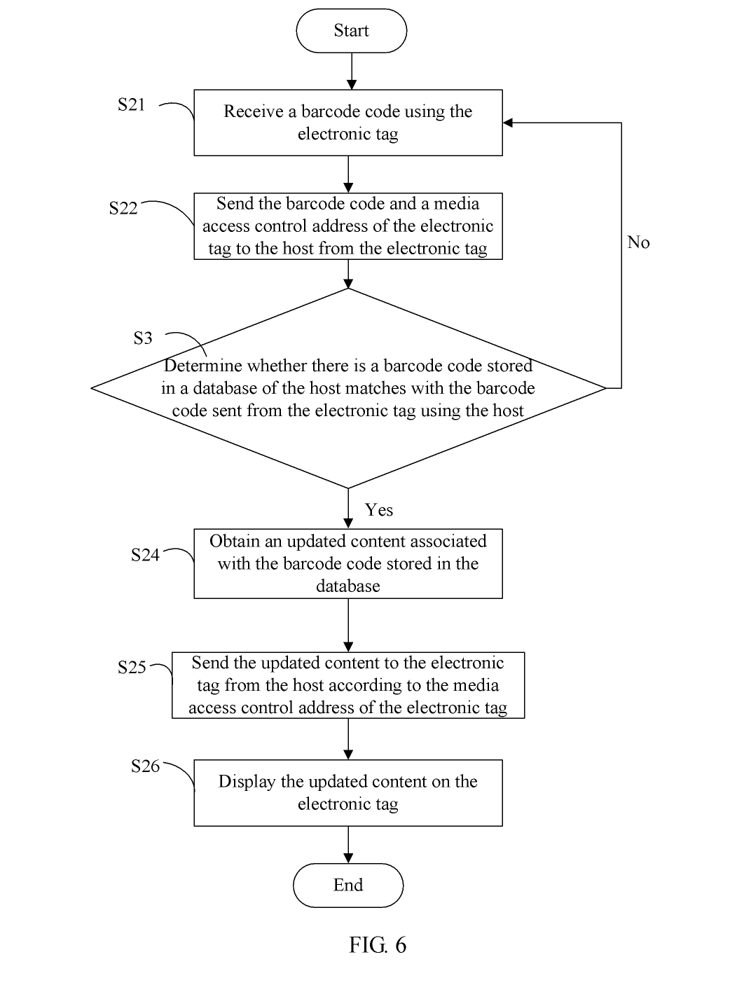

Referring to FIG. 6, a flowchart of a method for update the content displayed on the electronic tag 102 according to a second embodiment is illustrated. The method includes the following steps:

In step S21, receiving a barcode code using the electronic tag 102. The barcode input interface 32 of the electronic tag 102 receives the barcode code of the article sent by the barcode scanner 312.

In step S22, sending the barcode code and a media access control address of the electronic tag 102 to the host 82 from the electronic tag 102. The wireless communication unit 42 of the electronic tag 100 sends the code and a media access control address of the electronic tag 102 to the host 82.

In step S23, determining whether there is a barcode stored in a database of the host 80 matching with the barcode code sent from the electronic tag 102 using the host 80, if yes, go to step S24; if not, the process ends. The host 82 receives the barcode code sent by the electronic tag 102, and determines whether there is a barcode of stored in the database matching with the barcode code sent from the electronic tag 102.

In step S24, obtaining an updated content associated with the barcode code stored in the database. The host 80 obtains an updated content associated with the barcode code stored in the database.

In step S25, sending the updated content to the electronic tag 102 from the host 82 according to the media access control address of the electronic tag 102. The host 82 sending the updated content to the electronic tag 102 according to the media access control address of the electronic tag 102.

In step S26, displaying the updated content on the electronic tag 102. The wireless communication unit 42 of the electronic tag 102 receives the updated content, the E-paper driving unit 52 drives the E-paper screen 12 to display the updated content.

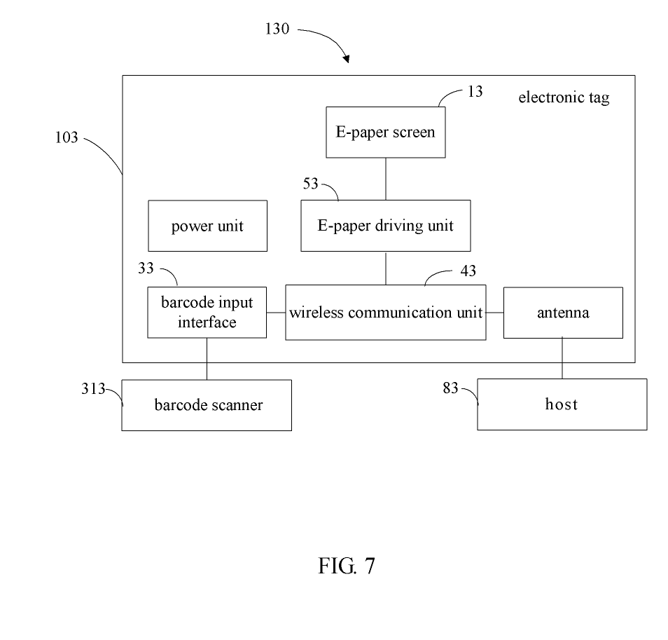

FIG. 7 shows an electronic tag system 130 for updating content displayed on an electronic tag 103 in accordance with a third embodiment. The electronic tag system 130 is similar to the electronic tag system 110 described in the first embodiment, the electronic tag system 120 includes an electronic tag 103, a barcode scanner 313 connected to the electronic tag 103 and a host 83. The electronic tag 103 includes an E-paper screen 13, a barcode input interface 33, a wireless communication unit 43 and an E-paper driving unit 53.

The electronic tag 103 receives a barcode code sent by the barcode scanner 313 via the barcode input interface 33, and the wireless communication unit 43 sends the barcode code and a predetermined identification code to the host 83 simultaneously. In this embodiment, the predetermined identification code may be a dynamic password, in other embodiments, the verification code can be a fixed password.

As in the first embodiment, the host 83 includes a database recording data concerning a number of articles. The host 83 receives the barcode code and the predetermined identification code sent by the electronic tag 103. The host 83 determines whether there is a barcode stored in the database matching with the barcode code sent from the electronic tag 103. The host 83 obtains an updated content associated with the barcode code stored in the database and sends the updated content and an identification code to the electronic tag 103.

The wireless communication unit 43 of the electrical tag 103 receives the updated content associated with the barcode code and an identification code sent by and from the host 83, the wireless communication unit 43 determines whether the received identification code matches with the predetermined identification code, if so, the E-paper driving unit 53 drives the E-paper screen 13 to display the updated content; if not, the E-paper driving unit 53 drives the E-paper screen 13 to display an error an error warning.

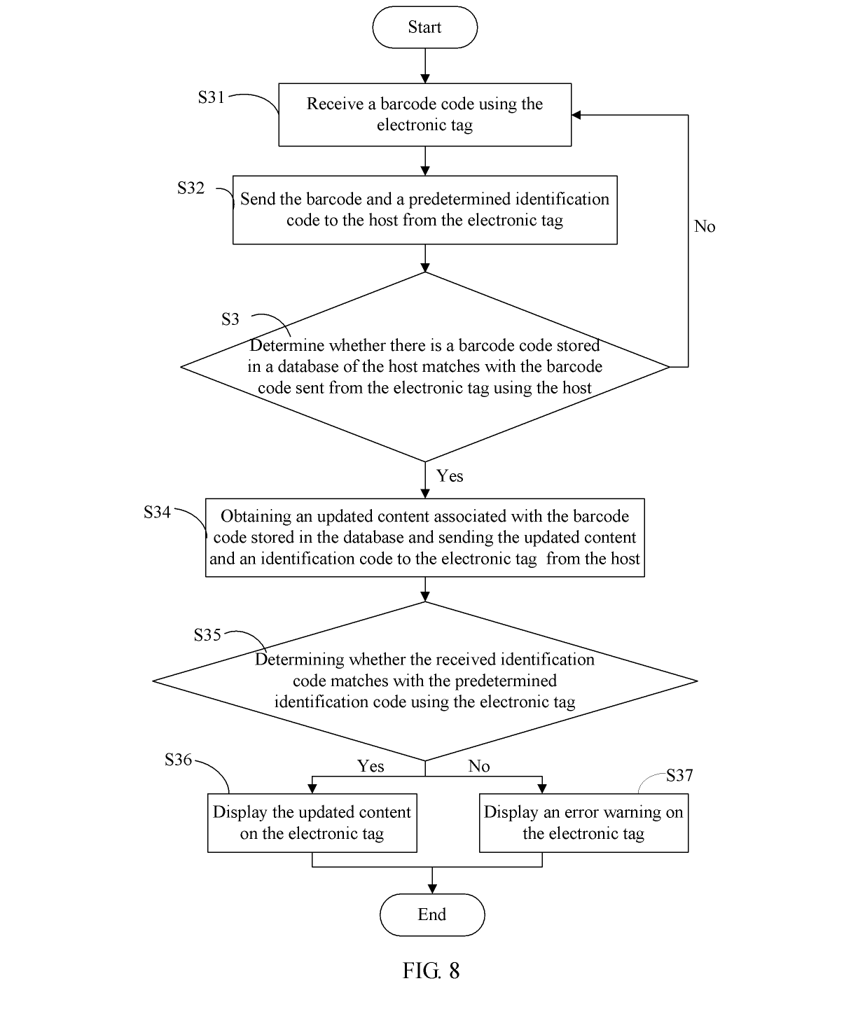

Referring to FIG. 8, a flowchart of a method for updating the content displayed on the electronic tag 103 according to the third embodiment is illustrated. The updating method includes the following steps:

In step S31, receiving a barcode code using the electronic tag 103.

In step S32, sending the barcode and a predetermined identification code to the host 83 from the electronic tag 103.

In step S33, determining whether there is a barcode code stored in a database of the host matching with the barcode code sent from the electronic tag using the host, if yes, the process going to step S4; if not, the process ending.

In step S34, obtaining an updated content associated with the barcode code stored in the database and sending the updated content and an identification code to the electronic tag 103 from the host 83.

In step S35, determining whether the received identification code matches with the predetermined identification code using the electronic tag 103, if so, go to step S36; if not, go to step S37.

In step S36, displaying the updated content on the electronic tag 103.

In step S37, displaying an error warning on the electronic tag 103.

It is to be understood, however, that even though numerous characteristics and advantages of the present disclosure have been set forth in the foregoing description, together with details of the structure and function of the present disclosure, the present disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A method for updating content displayed on an electronic tag, comprising:
S1, receiving a barcode code using the electronic tag;
S2, sending the barcode code to a host from the electronic tag;
S3, determining whether there is a barcode code stored in a database of the host matching with the barcode code sent from the electronic tag using the host, if yes, the process going to step S4; if not, the process ending;
S4, obtaining an updated content associated with the barcode code stored in the database and sending the updated content to the electronic tag from the host; and
S5, displaying the updated content on the electronic tag.

2. The method according to claim 1, wherein
the step S2 further comprises: sending the barcode code and a media access control address of the electronic tag to the host from the electronic tag; and
the step S4 further comprises: sending the updated content to the electronic tag from the host according to the media access control address of the electronic tag.

3. The method according to claim 1, wherein
the step S2 further comprises: sending the barcode code and a predetermined identification code to the host from the electronic tag;
the step S4 further comprises: sending the updated content and an identification code to the electronic tag from the host;
the step S5 further comprises: if the identification code sent from the host matches with the predetermined identification code, displaying the updated content on the electronic tag.

4. The method according to claim 3, wherein the step S5 further comprises: displaying an error warning if the identification code sent from the host does not match with the predetermined identification code.

5. An electronic tag, comprising:
a screen;
a barcode input interface configured for receiving a barcode code;
a wireless communication unit configured for sending the barcode code to a host, the wireless communication unit further configured for receiving an updated content associated with the barcode code sent by and from the host;
a driving unit configured for driving the screen to display the updated content.

6. The electronic tag according to claim 5, wherein the wireless communication unit is configured to send the barcode code and a media access control address of the wireless communication unit to the host.

7. The electronic tag according to claim 5, wherein the wireless communication unit sends the barcode code and a predetermined identification code to the host, the wireless communication unit is further configured to receive the updated content associated with the barcode code and an identification code sent by and from the host, and determine whether the received identification code matches with the predetermined identification code.

8. The electronic tag according to claim 7, wherein the driving unit is configured to drive the screen to display an error warning if the received identification code does not match with the predetermined identification code.

9. An electronic tag system, comprising:
a host;
a barcode scanner configured for scanning a barcode of an article to obtain a barcode code;
an electronic tag comprising:
a screen;
a barcode input interface configured for receiving the barcode code obtained by the barcode scanner;
a wireless communication unit configured for sending the barcode code to a host, the host being capable of updating content associated with the barcode code, the wireless communication unit further configured for receiving updated content associated with the barcode code sent by and from the host;
a driving unit configured for driving the screen to display the updated content.

10. The electronic tag system according to claim 9, wherein the wireless communication unit is configured to send the barcode code and a media access control address thereof to the host.

11. The electronic tag system according to claim 9, wherein the wireless communication unit is configured to send the barcode code and a predetermined identification code to the host, the wireless communication unit is further configured to receive the updated content associated with the barcode code and an identification code sent by and from the host, and determines whether the received identification code matches with the predetermined identification code.

12. The electronic tag system according to claim 11, wherein the driving unit is configured to drive to the screen display an error warning if the received identification code does not match with the predetermined identification code.
